(19) United States
(12) Patent Application Publication
(10) Pub. No.: US 2024/0081365 A1
(43) Pub. Date: Mar. 14, 2024

(54) Caffeine Candy with Additives

(71) Applicants: Taylor Howe, Bemidji, MN (US); Jon Labraaten, Bemidji, MN (US)

(72) Inventors: Taylor Howe, Bemidji, MN (US); Jon Labraaten, Bemidji, MN (US)

(21) Appl. No.: 17/931,358

(22) Filed: Sep. 12, 2022

(51) Int. Cl. A23G 3/48; A23G 3/42

(52) U.S. Cl. CPC A23G 3/48; A23G 3/42; A23V 2002/00

(57) ABSTRACT

A candy is described that has caffeine, and L-theanine, to reduce the negative side-effects of the caffeine.

### BACKGROUND

Many people use caffeine in modern society. They receive the caffeine from coffee drinks, energy drinks, and from other formulations.

Caffeine candies are known as ways to ingest caffeine without drinking a caffeinated beverage. However, caffeine candies are typically very large, so the caffeine is not too concentrated, and so the caffeine will not be ingested too quickly. If caffeine is too concentrated, and/or that amount of concentrated caffeine is ingested too quickly, the caffeine can cause negative side effects; including headaches, restlessness, shakiness and dizziness.

### SUMMARY

The present application describes a special caffeine candy which includes additives that remove or minimize the negative side effects of having a more concentrated amount of caffeine in a small candy.

Embodiments described additives which allow a larger amount of concentrated caffeine in a candy, while minimizing these negative side effects. This leads to the added benefit of the candy having a smaller size, and fewer calories because the smaller size allows less sugar, while providing a larger amount of caffeine.

### BRIEF DESCRIPTION OF THE DRAWINGS

FIG. 1 shows an exemplary candy piece.

### DETAILED DESCRIPTION

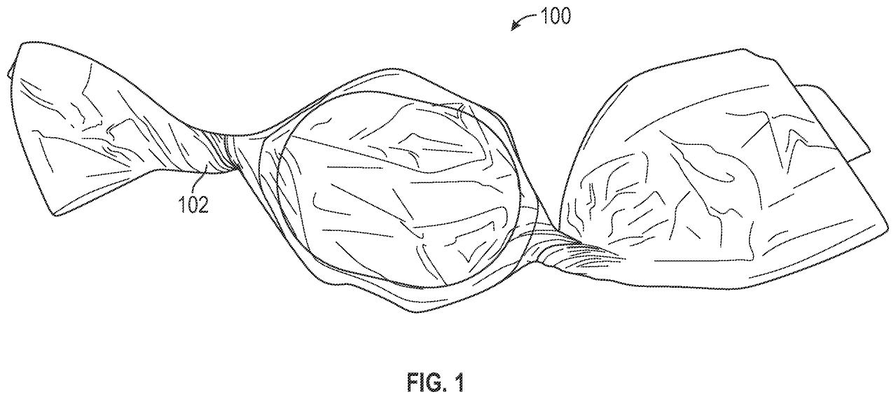

A caffeine candy is described which has added caffeine and other ingredients. FIG. 1 shows an exemplary candy piece 100, wrapped in a wrapper 102. The candy includes approximately 35 mg of caffeine per piece of candy.

In an embodiment, a sugar or sugar substitute is formed into a syrup. The sugar can be a monosaccharide such as glucose, or disaccharide or polysaccharide. The syrup is heated, and additional chemical compounds are added. Chemical compounds that are added include:

Caffeine, typically at a weight percentage which provides between 30 and 50 mg of caffeine per candy unit. This can be done by using caffeine as part of the candy mixture at a weight percent between 0.2 and 10 weight percent. The caffeine that is used can be from a natural source such as coffee extract or cola powder, or can be an artificial caffeine, but in an embodiment is preferably from brewed coffee.

An additional additive of L-Theanine at a ratio of n for every one part of caffeine that is in our candy. In embodiments, the value n is 1.5, meaning that for 10 mg of caffeine, we add 15 mg of L-Theanine. Based on our testing and research, this is the optimal ratio although other ratios can be used.

In another embodiment, the ratio n is 2.

The candy is then molded into the desired form, either a tablet, a ball, or any other shape. In an embodiment, the outer surface of the candy can be an edible outer surface that is different in its content than the core, for packaging purposes. The candy can be individually wrapped, each candy in its own clear package.

The candy piece 100 is currently 3.5 g in weight, 20.5 mm in diameter and about 11.2 mm thick. These candy pieces have less than 3 g of total carbohydrates per piece, and are less than 14 calories per piece.

In an embodiment, the operation uses real brewed coffee, natural caffeine powder, and at a higher ratio than used by other candies, but having the caffeine side effects moderated by the L-Theanine additive. This allows for a highly concentrated caffeine candy.

Although only a few embodiments have been disclosed in detail above, other embodiments are possible and the inventors intend these to be encompassed within this specification.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A caffeinated candy, comprising:
sugar,
a caffeine additive, and
an additive comprising L-theanine.

2. The candy as in claim 1, wherein there is a first weight of caffeine, and the second weight of L-Theanine, and the candy uses a defined ratio between the first weight and the second weight.

3. The candy as in claim 2, wherein the ratio is 1.5, and the second weight of L-Theanine, is 1.5 times higher than the first weight of caffeine.

4. The candy as in claim 1, wherein the caffeine additive is from brewed coffee.

5. The candy as in claim 1, wherein the caffeine additive provides 35 mg of caffeine.

6. The candy as in claim 1, wherein the caffeine additive provides 50 mg of caffeine.
